(19) United States
(12) Patent Application Publication
(10) Pub. No.: US 2026/0192460 A1
(43) Pub. Date: Jul. 9, 2026

(54) METHODS AND CONTROL SYSTEMS FOR CONTROLLING A ROBOTIC MANIPULATOR

(71) Applicant: Ocado Innovation Limited, Hatfield (GB)

(72) Inventors: Marco PALADINI, London (GB); Simon CHADWICK, Oxford (GB); Bingqing ZHANG, London (GB)

(21) Appl. No.: 19/132,676

(22) PCT Filed: Nov. 27, 2023
(86) PCT No.: PCT/EP2023/083186

§ 371 Date: May 23, 2025

(30) Foreign Application Priority Data
Nov. 28, 2022 (GB) 2217799.2

(51) Int. Cl. B25J 9/16; B25J 19/02

(52) U.S. Cl. CPC B25J 9/1697; B25J 9/1687; B25J 9/1689; B25J 19/023

(57) ABSTRACT

A control system and method for controlling a robotic manipulator, including obtaining depth data, based on an image of a container captured by a camera, following placement or removal of a first object into or from the container by the robotic manipulator. A determination is made, based on the depth data, as to whether a given object, comprising the first object or a different second object, in the container exceeds a height threshold associated with the container. In response to determining that the given object exceeds the height threshold, a signal indicative of the container being in an overheight state is generated. A control signal, based on the generated signal, is outputted and configured to control the robotic manipulator to manipulate the given object in the container.

### TECHNICAL FIELD

The present disclosure relates to robotic control systems, specifically systems and methods for use in packing objects into receptacles.

### BACKGROUND

Bin packing is a core problem in computer vision and robotics. The goal is to have a system with sensors and a robot to grip items using a suction gripper, parallel gripper, or other kind of robot end effector, and pack the items into a bin, e.g. a receptacle. The packing system may be combined with a bin picking system using the same or a different robot to first pick up the objects with random poses (positions/orientations) out of a different bin using the same or a different type of end effector.

There are issues with present systems, however, including a focus on planning and avoiding all contact during packing, and assuming only rigid objects are being packed. This means the systems are not practicable in real-world scenarios. For example, general purpose packing solutions typically do not take into consideration the specificity of the grocery packing problem. For example, packing algorithms should be able to cope with unexpected errors and have robustness when executing packing attempts in real-world scenarios.

### SUMMARY

There is provided a method for controlling a robotic manipulator, the method comprising: obtaining depth data, based on an image of a container captured by a camera, following placement or removal of a first object into or from the container by the robotic manipulator; determining, based on the depth data, whether a given object, comprising the first object or a different second object, in the container exceeds a height threshold associated with the container; generating, in response to determining that the given object exceeds the height threshold, a signal indicative of the container being in an overheight state; and outputting a control signal, based on the generated signal, configured to control the robotic manipulator to manipulate the given object in the container.

Optionally, the control signal is generated by teleoperation of the robotic manipulator. Optionally, the teleoperation is based on image data from another camera mounted on the robotic manipulator.

Optionally, the control signal is generated by a manipulation algorithm. Optionally, wherein the manipulation algorithm is configured to generate control signals for the robotic manipulator based on image data from another camera mounted on the robotic manipulator.

Optionally, the method comprises: obtaining further depth data, based on a further image of the container captured by the camera, following manipulation of the given object by the robotic manipulator; determining, based on the further depth image, whether the given object exceeds the height threshold; generating, in response to determining that the given object exceeds the height threshold, a further signal representative of the container being in the overheight state; and outputting the further signal in a request for teleoperation of the robotic manipulator to further manipulate the given object in the container. Optionally, the method comprises outputting a further control signal, based on the further generated signal, configured to control the robotic manipulator to manipulate the given object in the container.

Optionally, the height threshold is a first threshold, the overheight state is a first overheight state, the signal is a first signal, and the control signal is a first control signal, the method comprising: determining, based on the depth data, whether the given object in the container exceeds a second height threshold less than the first height threshold; generating, in response to determining that the given object exceeds the second height threshold and does not exceed the first height threshold, a second signal indicative of the container being in an second overheight state; and outputting a second control signal, generated by a manipulation algorithm based on the generated second signal, configured to control the robotic manipulator to manipulate the given object in the container. Optionally, the method comprises outputting a request, based on the generated first signal, for teleoperation of the robotic manipulator to manipulate the given object in the container. Optionally, the method comprises outputting the first control signal generated by the teleoperation of the robotic manipulator.

Optionally, the control signal is configured to control the robotic manipulator to regrasp the object, move the object, and release the object in the container.

Optionally, the control signal is configured to control the robotic manipulator to manipulate the object in the container by nonprehensile manipulation.

Optionally, the camera is mounted on the robotic manipulator.

Optionally, the camera is configured for use in an automated pick-and-place process in which the robotic manipulator is controlled to pick and place objects between selected containers, from a plurality of containers including the container, based on images captured by the camera.

Optionally, the height threshold corresponds to the top of the container.

Optionally, the height threshold is a height between 1 mm and 50 mm above the top of the container.

Optionally, determining whether the object exceeds the height threshold comprises searching for points in the depth data which are located in a predetermined search region defined based on the height threshold. Optionally, the search region is defined based on dimensions of the container.

Optionally, the signal indicative of the container being in the overheight state comprises location data representative of a location of the given object. Optionally, the location data is representative of a location of the given object relative to the camera or the robotic manipulator.

In a related aspect, there is provided a computer program comprising instructions which, when the program is executed by a computer, cause the computer to carry out the provided method. In a further related aspect, there is provided a computer-readable data carrier having stored thereon the computer program.

In a related aspect, there is provided a control system for a robotic manipulator, wherein the controller is configured to perform the provided method.

In a related aspect, there is provided a robotic packing system comprising the aforementioned control system and robotic manipulator for packing an object.

### BRIEF DESCRIPTION OF THE DRAWINGS

Embodiments will now be described by way of example only with reference to the accompanying drawings, in which like reference numbers designate the same or corresponding parts, and in which:

FIG. 1 is a schematic diagram of a robotic packing system according to an embodiment;

FIGS. 2A and 2B are schematic side views of a robotic packing system according to embodiments;

FIG. 3 is a perspective view of a robotic packing system including a representation of an overheight region according to an embodiment;

FIG. 4 is a perspective view of a robotic packing system located on a grid structure according to an embodiment; and

FIG. 5 shows a flowchart depicting a method for controlling a robotic manipulator according to an embodiment.

In the drawings, like features are denoted by like reference signs where appropriate, e.g. incremented by multiples of 10 or 100 according to the Figure number.

### DETAILED DESCRIPTION

In the following description, some specific details are included in the following description to provide a thorough understanding of various disclosed embodiments. However, one skilled in the relevant art will recognise that embodiments may be practised without one or more of these specific details or with other methods, components, materials, etc. In some instances, well-known structures associated with gripper assemblies and/or robotic manipulators (such as processors, sensors, storage devices, network interfaces, workpieces, tensile members, fasteners, electrical connectors, mixers, and the like) are not shown or described in detail to avoid unnecessarily obscuring descriptions of the disclosed embodiments.

Unless the context requires otherwise, the word “comprise” and its variants like “comprises” and “comprising” are to be construed in this description and appended claims in an open, inclusive sense, i.e. as “including, but not limited to”.

Reference throughout this specification to “one”, “an”, or “another” applied to “embodiment” or “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification do not necessarily refer to the same embodiment. Furthermore, the particular features, structures, or characteristics may be combined in any suitable manner in one or more embodiments, examples, or implementations.

It should be noted that, as used in this specification and the appended claims, the used forms “a”, “an”, and “the” include plural referents unless the content clearly dictates otherwise. It should also be noted that the term “or” is generally employed in its sense including “and/or” unless the content clearly dictates otherwise.

The language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components. In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

The term “pose” used throughout this specification represents the position and orientation of a given object in space. For example, a six-dimensional (6D) pose of the object includes respective values in three translational dimensions (e.g. corresponding to a position) and three rotational dimensions (e.g. corresponding to an orientation) of the object.

In general terms, this description introduces systems and methods to automatically check whether a container, usable to receive items manipulated by a robotic manipulator, is in an “overheight” state, e.g. has one or more items protruding from the top, e.g. the upper edge, of the container. This is done using depth data obtained via a camera, e.g. a depth image of the container captured after an interaction between the robotic manipulator and a container. It is determined, based on the depth image captured after a pick, placement, or pick-and-place operation, whether an object in the container is protruding above the top of the container (e.g.

a set height threshold at or above the upper edge or plane of the container). A positive determination triggers an overheight state for the container. The overheight state is signalled for the robotic manipulator to resolve (automatically and/or via teleoperation) the overheight state by manipulating the protruding object in the container.

The automatic overheight check is employed (e.g. as a microservice) to reduce the possibility of containers being packed or picked from by the robotic manipulator, e.g. at a picking station, leaving with one or more items protruding from the height of the tote, which could cause problems when storing or moving the container. For example, a container in an overheight state may be more difficult to store or move the container with equipment. In the context of an automated storage and retrieval system (ASRS or AS/RS), a container-handling device (e.g. a retrieval robot) may struggle to handle a container in the overheight state. For example, the one or more items protruding from the height of the tote may impede the container-handling device in handling the container.

Overall, the present system and methods avoid the need to install additional sensors, such as laser scanners or infrared presence sensors, and their associated cabling compared to known systems and methods. Thus, the space constraints of picking stations, particularly on or within a grid-like ASRS having a limited number of storage grid cells being taken up by the picking station, are more readily accommodated versus installing the additional sensors. Similarly, the present systems and methods avoid the need to mount such sensors (e.g. the laser or infrared scanners) on the robotic manipulator, which would add bulk and render the robotic manipulator impractical in performing the pick-and-place operations.

Instead, the present systems and methods utilise a camera, which may already be available to the robotic manipulator for other tasks, to detect overheight containers. For example, a point cloud captured by a depth camera is automatically scanned for any points in three-dimensional space that are measured above the container. Such points are measurements corresponding to one or more objects that cause the container to be in the overheight state. The measurement data from the point cloud, e.g. including the location of the one or more overheight portion of the one or more objects, can be used for controlling the robotic manipulator to manipulate the one or more objects in the container.

### General System

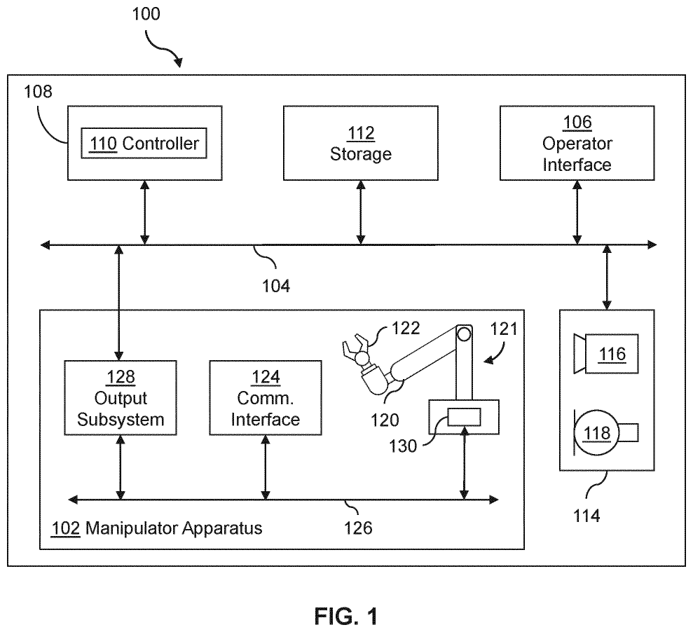

FIG. 1 illustrates an example of a robotic packing system 100 that may be adapted for use with the present assemblies, devices, and methods. The robotic packing system 100 may form part of an online retail operation, such as an online grocery retail operation. Still, it may also be applied to any other operation requiring the packing of items. For example, the robotic packing system 100 may also be adapted for picking or sorting articles, e.g. as a robotic picking/packing system sometimes referred to as a “pick and place robot”.

The robotic packing system 100 includes a manipulator apparatus 102 comprising a robotic manipulator 121. The manipulator 121 is an electro-mechanical machine comprising one or more appendages, such as a robotic arm 120, and an end effector 122 mounted on an end of the robotic arm 120. The end effector 122 is a device configured to interact with the environment in order to perform tasks, including, for example, gripping, grasping, releasably engaging or otherwise interacting with an item. Examples of the end effector 122 include a jaw gripper, a finger gripper, a magnetic or electromagnetic gripper, a Bernoulli gripper, a vacuum suction cup, an electrostatic gripper, a van der Waals gripper, a capillary gripper, a cryogenic gripper, an ultrasonic gripper, and a laser gripper.

The robotic manipulator 121 can grasp and manipulate an object. In the case of a pick and place application, the robotic manipulator 121 is configured to pick an item from a first location and place the item in a second location, for example.

The manipulator apparatus 102 is communicatively coupled via a communication interface 104 to other components of the robotic packing system 100, e.g. one or more optional operator interfaces 106 from which an observer may observe or monitor system 100 and the manipulator apparatus 102. The operator interfaces 106 may include a WIMP interface and an output display of explanatory text or a dynamic representation of the manipulator apparatus 102 in a context or scenario. For example, the dynamic representation of the manipulator apparatus 102 may include a video feed, for instance, a computer-generated animation. Examples of suitable communication interface 104 include a wire-based network or communication interface, an optical-based network or communication interface, a wireless network or communication interface, or a combination of wired, optical, and/or wireless networks or communication interfaces.

The example robotic packing system 100 also includes a control system 108, including at least one controller 110 communicatively coupled to the manipulator apparatus 102 and any other components of the robotic packing system 100 via the communication interface 104. The controller 110 comprises a control unit or computational device having one or more electronic processors. Embedded within the one or more processors is computer software comprising a set of control instructions provided as processor-executable data that, when executed, cause the controller 110 to issue actuation commands or control signals to the manipulator system 102. For example, the actuation commands or control signals cause the manipulator 121 to carry out various methods and actions, such as identifying and manipulating items.

The one or more electronic processors may include at least one logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), or the like. In some implementations, the controller 110 is a smaller processor-based device like a mobile phone, single-board computer, embedded computer, or the like, which may be termed or referred to interchangeably as a computer, server, or analyser. The set of control instructions may also be provided as processor-executable data associated with the operation of the system 100 and manipulator apparatus 102 included in a non-transitory computer-readable storage device 112, which forms part of the robotic packing system 100 and is accessible to the controller 110 via the communication interface 104.

In some implementations, the storage device 112 includes two or more distinct devices. The storage device 112 can, for example, include one or more volatile storage devices, e.g. random access memory (RAM), and one or more non-volatile storage devices, e.g. read-only memory (ROM), flash memory, magnetic hard disk (HDD), optical disk, solid-state disk (SSD), or the like. A person of skill in the art will appreciate storage may be implemented in a variety of ways such as a read-only memory (ROM), random access memory (RAM), hard disk drive (HDD), network drive, flash memory, digital versatile disk (DVD), any other forms of computer- and processor-readable memory or storage medium, and/or a combination thereof. Storage can be read-only or read-write as needed.

The robotic packing system 100 includes a sensor subsystem 114 comprising one or more sensors that detect, sense or measure conditions or states of the manipulator apparatus 102 and/or conditions in the environment or workspace in which the manipulator 121 operates and produce or provide corresponding sensor data or information. Sensor information includes environmental sensor information, representative of environmental conditions within the workspace of the manipulator 121, as well as information representative of condition or state of the manipulator apparatus 102, including the various subsystems and components thereof, and characteristics of the item to be manipulated. The acquired data may be transmitted via the communication interface 104 to the controller 110 for directing the manipulator 121 accordingly. Such information can, for example, include diagnostic sensor information that is useful in diagnosing a condition or state of the manipulator apparatus 102 or the environment in which the manipulator 121 operates.

Such sensors include, for example, one or more cameras or imagers 116 (e.g. responsive within visible and/or non-visible ranges of the electromagnetic spectrum including, for instance, infrared and ultraviolet). The one or more cameras 116 may include a depth camera, e.g. a stereo camera, to capture depth data alongside colour channel data in an imaged scene. Other sensors of the sensor subsystem 114 may include one or more of: contact sensors, force sensors, strain gages, vibration sensors, position sensors, attitude sensors, accelerometers, radars, sonars, lidars, touch sensors, pressure sensors, load cells, microphones 118, meteorological sensors, chemical sensors, or the like. In some implementations, the sensors include diagnostic sensors to monitor a condition and/or health of an on-board power source within the manipulator apparatus 102 (e.g. a battery array, ultra-capacitor array, or fuel cell array).

In some implementations, the one or more sensors comprise receivers to receive position and/or orientation information concerning the manipulator 121. For example, a global position system (GPS) receiver to receive GPS data, two more time signals for the controller 110 to create a position measurement based on data in the signals, such as time-of-flight, signal strength, or other data to effect a position measurement. Also, for example, one or more accelerometers, which may also form part of the manipulator apparatus 102, could be provided on the manipulator 121 to acquire inertial or directional data, in one, two, or three axes, regarding the movement thereof.

The robotic manipulator 121 of the system 100 may be piloted by a human operator at the operator interface 106. In a human operator-controlled (or “piloted”) mode, the human operator observes representations of sensor data, e.g. video, audio, or haptic data received from the one or more sensors of the sensor subsystem 114. The human operator then acts, conditioned by a perception of the representation of the data, and creates information or executable control instructions to direct the manipulator 121 accordingly. In the piloted mode, the manipulator apparatus 102 may execute control instructions in real-time (e.g. without added delay) as received from the operator interface 106 without taking into account other control instructions based on the sensed information.

In some implementations, the manipulator apparatus 102 operates autonomously, i.e. without a human operator creating control instructions at the operator interface 106 for directing the manipulator 121. The manipulator apparatus 102 may operate in an autonomous control mode by executing autonomous control instructions. For example, the controller 110 can use sensor data from one or more sensors of the sensor subsystem 114. The sensor data is associated with operator-generated control instructions from one or more times during which the manipulator apparatus 102 was in the piloted mode to generate autonomous control instructions for subsequent use. For example, deep learning techniques can be used to extract features from the sensor data. Thus, in the autonomous mode, the manipulator apparatus 102 can autonomously recognise features or conditions of its environment and the item to be manipulated. In response, the manipulator apparatus 102 performs one or more defined acts or tasks. For example, the manipulator apparatus 102 performs a pipeline or sequence of acts or tasks.

In some implementations, the controller 110 autonomously recognises features or conditions of the environment surrounding the manipulator 121 and one or more virtual items composited into the environment. The environment is represented by sensor data from the sensor subsystem 114. In response to being presented with the representation, the controller 110 issues control signals to the manipulator apparatus 102 to perform one or more actions or tasks.

In some instances, the manipulator apparatus 102 may be controlled autonomously at a given time while being piloted, operated, or controlled by a human operator at another time. That is, the manipulator apparatus 102 may operate under the autonomous control mode and change to operate under the piloted (i.e. non-autonomous) mode. In another mode of operation, the manipulator apparatus 102 can replay or execute control instructions previously carried out in the piloted mode. That is, the manipulator apparatus 102 can operate based on replayed pilot data without sensor data.

The manipulator apparatus 102 further includes a communication interface subsystem 124 (e.g. a network interface device) communicatively coupled to a bus 126 and which provides bi-directional communication with other components of the system 100 (e.g. the controller 110) via the communication interface 104. The communication interface subsystem 124 may be any circuitry effecting bidirectional communication of processor-readable data and processor-executable instructions, such as radios (e.g. radio or microwave frequency transmitters, receivers, transceivers) ports, and/or associated controllers. Suitable communication protocols include FTP, HTTP, Web Services, SOAP with XML, cellular (e.g. GSM, CDMA), Wi-Fi® compliant, Bluetooth® compliant, and the like.

The manipulator apparatus 102 further includes a motion subsystem 130, communicatively coupled to the robotic arm 120 and end effector 122. The motion subsystem 130 comprises one or more motors, solenoids, other actuators, linkages, drive-belts, or the like operable to cause the robotic arm 120 and/or end effector 122 to move within a range of motions in accordance with the actuation commands or control signals issued by the controller 110. The motion subsystem 130 is communicatively coupled to the controller 110 via the bus 126.

The manipulator apparatus 102 also includes an output subsystem 128 comprising one or more output devices, such as speakers, lights, or displays that enable the manipulator apparatus 102 to send signals into the workspace to communicate with, for example, an operator and/or another manipulator apparatus 102.

A person of ordinary skill in the art will appreciate the components in manipulator apparatus 102 may be varied, combined, split, omitted, or the like. In some examples, one or more of the communication interface subsystem 124, the output subsystem 128, and the motion subsystem 130 are combined. In other instances, one or more subsystems (e.g. the motion subsystem 130) are split into further subsystems.

### Robotic System

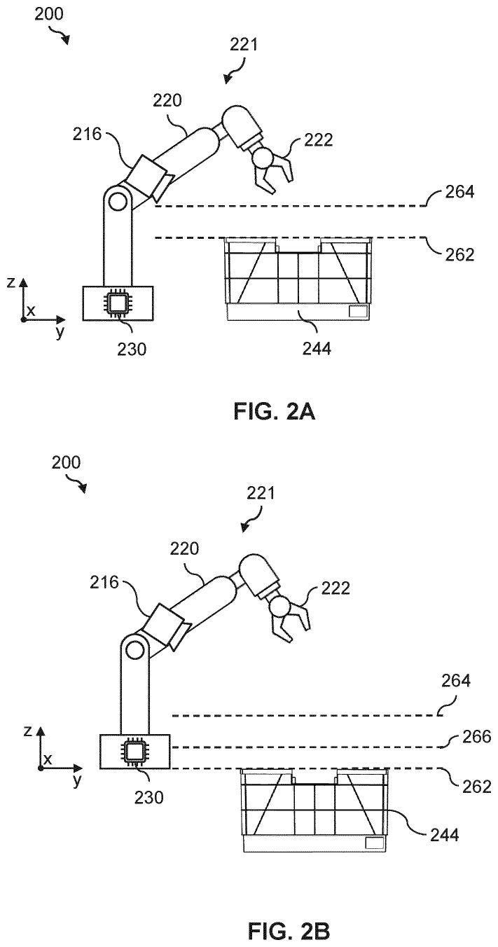

FIG. 2 shows an example of a robotic packing system 200 including a robotic manipulator 221, e.g. an implementation of the robotic manipulator 121 described in previous examples. In accordance with such examples, the robotic manipulator 221 includes a robotic arm 220, an end effector 222, and a motion subsystem 230. The motion subsystem 230 is communicatively coupled to the robotic arm 220 and end effector 222 and configured to cause the robotic arm 220 and/or end effector 222 to move in accordance with actuation commands or control signals issued by a controller (not shown). The controller, e.g. controller 110 described in previous examples, is part of a manipulator apparatus with the robotic manipulator 221.

The robotic manipulator 221 is arranged to manipulate an object, e.g. grasped by the end effector 222, in the workspace to pack the object into a receiving space, e.g. a container (or “bin” or “tote”) 244. For example, the robotic packing system 200 may be implemented in an automated storage and retrieval system (ASRS), e.g. in a picking station thereof. An ASRS typically includes multiple containers arranged to store items and one or more load-handling device or automated guided vehicle (AGV) to retrieve one or more containers 244 during fulfilment of a customer order. At a picking station, items are picked from and/or placed into the one or more retrieved containers 244. The one or more containers in the picking station may be considered as being storage containers or delivery containers. A storage container is a container which remains within the ASRS and holds eaches of products which can be transferred from the storage container to a delivery container. A delivery container is a container that is introduced into the ASRS when empty and that has a number of different products loaded into it. A delivery container may comprise one or more bags or cartons into which products may be loaded. A delivery container may be substantially the same size as a storage container. Alternatively, a delivery container may be slightly smaller than a storage container such that a delivery container may be nested within a storage container.

The robotic packing system 200 can therefore be used to pick an item from one container, e.g. a storage container, and place the item into another container, e.g. a delivery container, at a picking station. The picking station may thus have two sections: one section for the storage container and one for the delivery container. The arrangement of the picking station, e.g. the sections thereof, can be varied and selected as appropriate. For example, the two sections may be arranged on two sides of an area or with one section above or below the other. In some cases, the picking station is located away from the storage locations of the containers in the ASRS, e.g. away from the storage grid in a grid-based ASRS. The load handling devices may therefore deliver and collect the containers to/from one or more ports of the ASRS which are linked to the picking station, e.g. by chutes. In other instances, the picking station is located to interact directly with a subset of storage locations in the ASRS, e.g. to pick and place items between containers located at the subset of storage locations. For example, in the case of a grid-based ASRS, the picking station may be located on the grid of the ASRS.

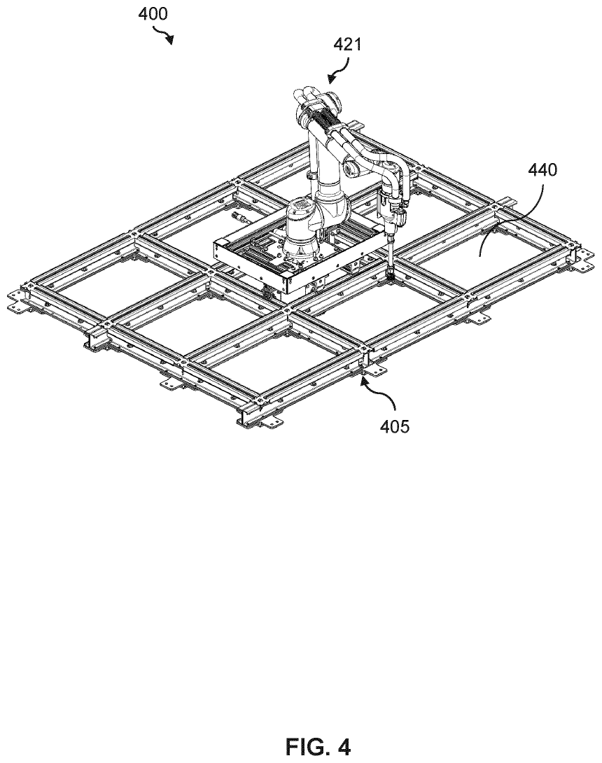

FIG. 4 shows an example of a robotic packing system 400, comprising a robotic manipulator 421 as described, located on a section of grid 405 which forms, in examples, part of the ASRS. For instance, load handling devices (or “retrieval robots”) may travel along the two orthogonal axes of the grid 405 to retrieve containers from stacks of containers below the grid 405. Meanwhile, the robotic manipulator 421 located at the picking station on the grid is configured to pick and pack items between containers, e.g. those containers retrieved by the retrieval robots, arranged in an array of grid spaces forming part of the picking station. Containers (not shown in FIG. 4) located in the picking locations 440 may be storage containers or delivery containers.

In the schematic depiction of the robotic packing system 400 shown in FIG. 4, comprising a robotic picking station on the ASRS, the robotic manipulator 421 is received on a plinth connected to the framework of the storage system, e.g. the grid structure 405, such that the robotic arm is mounted on the storage system. For example, the plinth may be connected to one or more of the upright members and/or horizontal members of the storage system. In an alternative, a mount may be used to connect the robotic arm to the framework of the grid structure 405. For example, one or more mount members may mount the robotic arm 421, e.g. the base of the robotic arm, to one or more members of the storage system.

The robotic manipulator 221, 321 of the present system 200, 300 may comprise one or more end effectors 222, 322. For example, the robotic manipulator 221, 321 may comprise more than one different type of end effector. In some examples, the robotic manipulator 221, 321 may be configured to exchange a first end effector for a second effector. In some cases, a controller may send instructions to the robotic manipulator 221, 321 as to which end effector 222, 322 to use for each different object or product (or stock keeping unit, “SKU”) being packed. Alternatively, the robotic manipulator 221, 321 may determine which end effector to use based on the weight, size, shape etc. of a product. Previous successes and/or failures to grasp and move an item may be used to update the selection of an end effector for a particular SKU. This information may be fed back to the controller so that the success/failure information can be stored and shared between different picking/packing stations. A robotic manipulator 221, 321 may be able to change end effectors. For example, the picking/packing station may comprise a storage area which can receive one or more end effectors. The robotic manipulator 221, 321 may be configured such that an end effector in use can be removed from the robotic arm 220 and placed into the end effector storage area. A further end effector may then be removably attached to the robotic arm 220 such that it can be used for subsequent picking/packing operations. The end effector may be selected in accordance with planned picking/packing operations.

The robotic packing system 200 of FIG. 2 includes a depth camera 216 mounted on the robotic manipulator 221. For example, the depth camera 216 may be mounted on, or near to, the end effector, e.g. on or near the wrist of the robotic arm. Additionally, or alternatively, a depth camera 216 may be mounted on or near to the elbow of the robotic arm. In other examples, the depth camera 216 is supported by a frame structure 240, e.g. comprising a scaffold on which the depth camera 216 is mounted. The depth camera, also known as an RGB-D camera or a “range camera”, generates depth information using techniques such as time-of-flight, LIDAR, interferometry, and stereo triangulation, by illuminating the scene with “structured light” or an infrared speckle pattern.

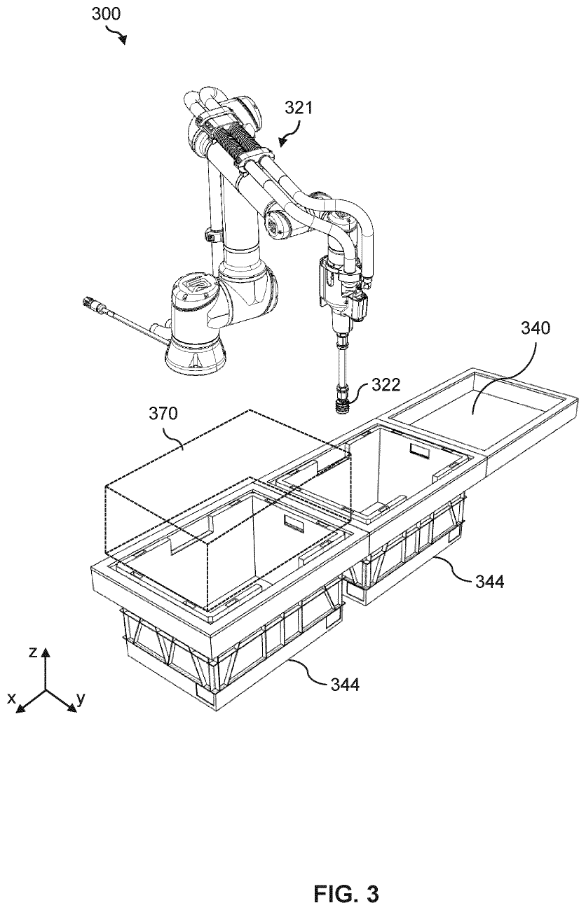

The depth camera is arranged to capture depth data, e.g. a depth image, of a scene including one or more container locations 340, for example as shown in FIG. 3. Respective containers 344 can be arranged in respective container locations 340 such that the end effector 322 of the robotic manipulator 321 can interact with items stored therein. For example, the depth camera is arranged such that it has a view of the workspace of the robotic manipulator 221 including a given container 344 following placement of an object into the said container 344, or removal of an object from the container 344, by the robotic manipulator 321. As previously described, the container locations 340 may be at a picking station and/or correspond with storage locations in a grid structure of a grid-based ASRS.

In examples, the depth camera is configured for use in an automated pick-and-place process in which the robotic manipulator 321 is controlled to pick and place objects between selected containers 344 based on depth images captured by the depth camera.

The depth camera 216 may correspond to the one or more cameras or imagers 116 in the sensor subsystem 114 of the robotic packing system 100 described with reference to FIG. 1. As described, the depth camera 216 of the robotic packing system 200 is configured to capture depth images. For example, a depth (or “depth map”) image includes depth information of the scene viewed by the camera 216.

A point cloud generator may be associated with the depth camera or imager 216, e.g. LIDAR sensor, positioned to view the workspace, e.g. a given container 344 and its contents. Examples of structured light devices for use in point cloud generation include Kinect™ devices by Microsoft®, time of flight devices, ultrasound devices, stereo camera pairs and laser stripers. These devices typically generate depth map images that are processed by the point cloud generator to generate a point cloud.

It is usual to calibrate depth map images for aberrations in the lenses and sensors of the camera. Once calibrated, the depth map can be transformed into a set of metric 3D points, known as a point cloud. Preferably, the point cloud is an organised point cloud which means that each three-dimensional point lies on a line of sight of a distinct pixel resulting in a one-to-one correspondence between 3D points and pixels. Organisation is desirable because it allows for more efficient point cloud processing. In a further part of the calibration process the pose of the camera, namely its position and orientation, relative to a reference frame of the robotic packing system 200 or robotic manipulator 221, is determined. The reference frame may be the base of the robotic manipulator 221, however, any known reference frame will work, e.g. a reference frame situated at a wrist joint of the robot arm 220. Accordingly, a point cloud may be generated based on a depth map and information about the lenses and sensors used to generate the depth map. Optionally, the generated depth map may be transformed into the reference frame of the robotic packing system 200 or robotic manipulator 221. For simplicity, the depth camera or imager 116, 216 is shown as a single unit in FIGS. 1, 2A and 2B. However, as will be appreciated, each of the functions of depth map generating and depth map calibration could be performed by separate units, for example, the depth map calibration means could be integrated in the control system of the robotic packing system 100, 200.

### Control System

A control system for the robotic manipulator 221, e.g. the control system 108 communicatively coupled to the manipulator apparatus of previous examples, is configured to obtain the depth data based on an image captured by the depth camera 216. As described herein, the image includes a container 244, 344 following placement/removal of an object into/from the container 244, 344 by the robotic manipulator 221, 321.

The control system processes the depth data to determine whether a given object, which may be the object just placed into the container or a different object already located in the container, exceeds a height threshold associated with the container. An object is considered to exceed the height threshold, for example, when at least a portion of the object exceeds the height threshold.

In some examples, the height threshold corresponds to the top of the container, e.g. is representable as a plane coincident with the top of the container. Thus, an object in the container which extends beyond the top of the container can be considered to exceed the height threshold. FIG. 2A shows another example where the height threshold 264 is offset from a plane 262 coincident with the top of the container 244. For example, the height threshold 264 is between 1 mm and 50 mm above the top of the container. The height threshold 264 may therefore be representable as a plane parallel to the plane 262 coincident with the top of the container 244. The parallel planes 262, 264 may be coincident or offset by a predetermined distance, e.g. between 1 mm and 50 mm.

In examples, determining whether a given object in the container 244, 344 exceeds the height threshold 264 involves searching for points in the depth data which lie in a search region (or “overheight region”) 370 (shown in FIG. 3) above the container 244, 344. The search region 370 is bounded (in the z direction) by the height threshold as the lower bound, for example.

An upper bound of the search region 370 (in the z direction) may be set at a predetermined height or depth value or a set depth differential from the lower bound to define a height of the search region 370, for example. The bounds of the search region 370 in the other, orthogonal (x and y) directions are based on the dimensions of the container 344 in examples. For example, the length and width of the container 344 are set as the length and width of the search region 370. Thus, the search region 370 lies above the container in the depth space, with its lower boundary set as the height threshold, either coinciding with the top of the container or at a predetermined height above top of the container.

The control system may, therefore, process the depth data to find features with associated depth value within the bounds of the search region 370. For example, the control system may extract the features from the depth data, e.g. by deleting from the image features with depth values outside of the search region 370. Where the depth data comprises a point cloud, for example, the control system extracts points from the point cloud that lie within the search region 370, e.g. by deleting points which are outside the search region 370 from the point cloud. The control system can thus isolate the features of the depth data which are within the search region 370, e.g. “overheight” features or points, based on the depth information.

In some examples, outlier points detected in the search region 370 are removed from the determined overheight points. For example, where overheight points are clustered within a region of the search region 370, they can be considered a portion of an overheight object. On the other hand, where isolated points are detected in the search region 370, e.g. far away from any detected cluster, these outliers are removed from the set of overheight points. For example, a statistical method is used to remove points that are further away from their neighbours compared to the average distance for the point cloud using a threshold (e.g. based on the standard deviation of the average distances across the point cloud). Other methods for filtering the depth data, e.g. point cloud, can be employed, such as fitting a smooth surface to the points and remove outliers with high distance from the fitted surface.

In some cases, the search region 370 is modified to exclude portions of the surroundings, e.g. the picking station. Thus, the search region 370 may first be defined based on the overheight thresholds and container dimensions and then modified to exclude, e.g. subtract, any overlapping exclusion regions, defined based on the dimensions of features in the surrounding area, from the search region 370.

In response to determining that an object exceeds the height threshold, the control system generates a signal indicative of the container being in an overheight state. For example, the overheight state is a defined state for a container representative of the container containing an object which extends above the set height threshold.

The control system outputs a control signal, based on the generated signal, configured to control the robotic manipulator 221, 321 to manipulate the overheight object detected in the container. For example, the signal indicative of the container being in an overheight state may be sent between different controllers of the control system, e.g. from a controller associated with the depth camera 216, e.g. in a vision system comprising the depth camera 216, to a controller associated with the motion subsystem 230 configured to cause the robotic arm 220 and/or end effector 222 to move in accordance with control signals issued by the controller. In such cases, the control signal may be generated by a manipulation algorithm based on the overheight signal. The manipulation algorithm is configured, for example, to generate control signals for the robotic manipulator 221, 321 based on image data from another camera (not shown) mounted on the robotic manipulator 221, 321. For example, a camera mounted at the wrist of the robotic manipulator 221, 321 can obtain images of the scene including the end effector 222, 322 to control the end effector 222, 322 in its environment. In these examples the robotic packing system 200, 300 can automatically, e.g. without human intervention, manipulate the overheight object in the container detected by the control system based on depth images from the depth camera 216.

In other examples, the control signal is generated by teleoperation of the robotic manipulator. For example, the signal indicative of the container being in an overheight state may be sent externally from the control system, e.g. in a request for teleoperation of the robotic manipulator. The control system may receive the control signal generated by teleoperation, e.g. at an interface, and output the control signal, e.g. from a controller associated with the motion subsystem 230 of the robotic manipulator 221, 321. As described for the manipulation algorithm, the teleoperation can be done based on image data from another camera mounted on the robotic manipulator 221, 321, e.g. at the wrist thereof. During teleoperation, a human operator controls the movements of the robotic manipulator 221, 321 remotely, e.g. at a different location. A communication channel between the operator and the robotic manipulator 221, 321 allows signals to be transmitted therebetween. For example, perception information can be sent from the control system of the robotic manipulator 221, 321, e.g. including image data captured by a camera mounted on the robotic manipulator 221, 321. In some cases, the detected overheight heat map is overlaid on the colour image displayed to the teleoperator.

The teleoperator may generate the control signals using a human interface device, e.g. a joystick, gamepad, keyboard, pointing device or other input device. The control signals are sent to the robotic manipulator to control it via the control system.

In some cases, a hybrid of the manipulation algorithm and teleoperation is used to generate the control signal for the robotic manipulator 221, 321. For example, the operator may use the human input device to define a region of the overheight item to be grasped by the robotic manipulator 221, 321, e.g. a flat surface of a box when the end effector 222, 322 comprises a suction end effector (as shown in the example of FIG. 3). The defined region of the overheight item to be grasped can then be used as an input into an automatic picking attempt. In other words, in the hybrid case, the grasp generation can be done with manual input rather than fully automatically by the manipulation algorithm. In some cases, the teleoperation command, e.g. generated by the teleoperator, comprises a strategy, for example a motion strategy and/or grasp strategy. The teleoperator may click a single point in an image of the scene to cause the robotic manipulator to move in the direction of, e.g. to, the clicked (“target”) point in the scene, for example. The robotic manipulator may be moved to the target point from the edge of the overheight region, which is automatically computed, for example. If the automatic picking attempt is still not successful in grasping or otherwise manipulating the overheight object, then the operator may fully operate the robotic manipulator 221, 321 to manipulate the object, as described above. It should be understood that some form of machine learning technology may be utilised in the automatic manipulation algorithm. In such a case, data generated during teleoperation of the robotic manipulator 221, 321 by a remote operator may be used to refine the manipulation algorithm used in the automatic operation of the robotic manipulator 221, 321.

The outputted control signal, e.g. generated by the manipulation algorithm and/or teloperation, is configured to control the robotic manipulator 221, 321 to manipulate the overheight object detected in the container. For example, the control signal is configured to control the robotic manipulator 221, 321 to regrasp the object, move the object, and release the object in the container. Additionally, or alternatively, the control signal is configured to control the robotic manipulator 221, 321 to manipulate the object in the container by nonprehensile manipulation. Nonprehensile manipulation involves the robotic manipulator 221, 321 manipulating an object without grasping the object, e.g. by nudging the object. The objective of the manipulation per the control signal is to reposition the overheight object detected in the container so that it is no longer above the height threshold and the container is not in the overheight state.

In examples, the control system performs another overheight check after the manipulation of the overheight object per the outputted control signal. For example, the control system obtains a further depth image, from the depth camera 216, of the container 244, 344 following manipulation of the overheight object by the robotic manipulator 221, 321. The control system can then determine, based on the further depth image, whether the given object exceeds the height threshold. In response to determining that the given object exceeds the height threshold, the control system generates a further signal representative of the container being in the overheight state, for example.

The further signal output by the control system may comprise a request for teleoperation of the robotic manipulator to further manipulate the given object in the container. Thus, in examples where the initial determination of the overheight object in the container results in automatic manipulation of the overheight object by the robotic manipulator 221, 321, the further determination of the container being in the overheight state (due to the initial overheight object or a different object in the container) may result in a teleoperation request to resolve the overheight state of the container.

A further control signal, based on the further generated signal representative of the container 244, 344 being in the overheight state, is outputted by the control system in examples. The further control signal is configured to control the robotic manipulator to manipulate the overheight object in the container 244, 344, e.g. to attempt to resolve the overheight state of the container 244, 344 determined in the check after the initial manipulation of the overheight object.

As described previously for the control signal configured to control the robotic manipulator 221, 321, the further control signal may be generated by teleoperation or an automated manipulation algorithm and output via a controller associated with the motion subsystem 230 of the robotic manipulator 221, 321.

Another check can be performed, additionally or alternatively to the further overheight check, after manipulation of the overheight object per the outputted control signal. Namely, the pose of the container can be re-determined to check if the container has moved due to the manipulation by the robotic manipulator 221, 321. For example, the overheight region (370) can be re-computed after the interaction with the robotic manipulator, e.g. based on the new container pose.

In some examples, there is more than one height threshold for determining the overheight state of the container. FIG. 2B illustrates such a scenario. In this example, there is a first height threshold 264, as described in previous examples, wherein the control system is configured to generate, in response to determining that a given object exceeds the first height threshold 264, a first signal indicative of the container being in a first overheight state. The control system is further configured to output a first control signal, based on the generated first signal, configured to control the robotic manipulator 221 to manipulate the given object in the container 244.

In the example of FIG. 2B, the control system is also configured to determine, based on the depth image captured by the depth camera 216, whether a given object in the container exceeds a second height threshold 266 less than the first height threshold 264. For example, the first height threshold 264 is a more severe height threshold, i.e. at a greater height above the container 244, than the second height threshold 266. The first and second height thresholds 264, 266 may be considered as parallel planes offset from each other. For example, the two planes have a predetermined displacement between them, or respective predetermined displacements from the top of the container 244, in the vertical z-direction. In some examples, the second height threshold 266 corresponds to the top of the container, e.g. is representable as a plane coincident with the top of the container.

In response to determining that the given object exceeds the second height threshold but not the first height threshold, the control system is configured to generate a second signal indicative of the container being in an second overheight state, for example. Thus, the first and second overheight states allow for a discrimination between levels of overheight, e.g. how much a given object is extending beyond the top boundary of the container 244, rather than a binary determination of the container being in an overheight state or not.

In such examples involving different overheight states for the container, different actions can be taken depending on the overheight state that is determined by the control system. For example, the control system is configured to output a second control signal, generated by a manipulation algorithm based on the generated second signal, configured to control the robotic manipulator to manipulate the given object in the container. Therefore, the control system causes an automatic response to the second overheight state involving the manipulation algorithm generating the second control signal for manipulating the overheight object in an attempt to resolve the second overheight state of the container 244.

In some cases, the control system outputs a teleoperation request if the first signal, indicative of the container being in the first overheight state, is generated. Thus, there is a different response to the first overheight state, which relates to the higher first height threshold having been exceeded by the object in the container, than the second overheight state in these examples. While the less severe second overheight state may cause an automatic response involving the manipulation algorithm to generate the control signal, the more severe first overheight state causes a more involved response including a teleoperation request. In the latter case, the control signal for controlling the robotic manipulator 221 to manipulate the object may be generated by teleoperation and obtained by the control system to implement at the robotic manipulator 221, e.g. via the motion subsystem 230, as described in other examples.

### Control Method

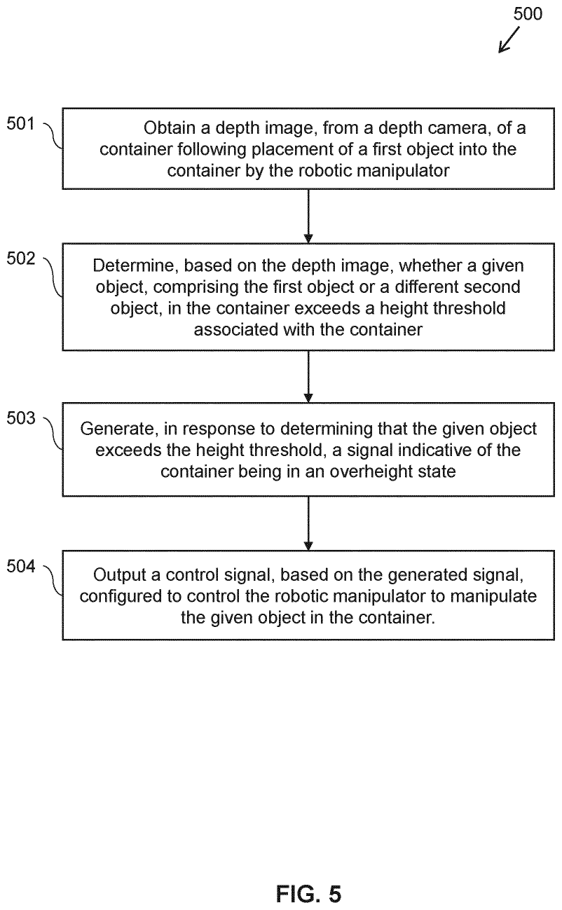

FIG. 5 shows a computer-implemented method 500 for controlling a robotic manipulator. The robotic manipulator may be one of the example robotic manipulators 121, 221, 321, 421 described with reference to FIGS. 1 to 4. The method 500 may be performed by one or more components of the system 100 previously described, for example the control system 108 or controller 110.

At 501, depth data based on an image of a container, is obtained following placement of a first object into the container, or removal of the first object from the container, by the robotic manipulator. The image is captured by a camera with a view of the container, for example the camera is mounted on the robotic manipulator. In examples, the depth data comprises a point cloud.

At 502, the method 500 involves determining, based on the depth data, whether a given object, comprising the first object or a different second object, in the container exceeds a height threshold associated with the container. An object is considered to exceed the height threshold, for example, when at least a portion of the object exceeds the height threshold. In examples, it is determined whether a given object (e.g. the first or second object) protrudes above a threshold plane having a set height in the space based on the height of the container. For example, the threshold plane coincides with the top edge of the container or is offset above the top edge of the container by a set amount.

At 503, in response to determining that the given object exceeds the height threshold, a signal indicative of the container being in an overheight state is generated. For example, the generated signal can be used as an input to a manipulation algorithm for generating control signals for the robotic manipulator, or output to a teleoperation system for a remote operator to generate control signals for the robotic manipulator.

At 504, a control signal, based on the generated signal and configured to control the robotic manipulator to manipulate the given object in the container, is outputted. As described in herein, the control signal may be generated by teleoperation of the robotic manipulator and/or a manipulation algorithm, for example based on image data from another camera mounted on the robotic manipulator. The other camera is configured to obtain perception, e.g. visual, data associated with the environment of the robotic manipulator for use in controlling the robotic manipulator.

In some examples, the method 500 involves obtaining further depth data based on a further image of the container captured following manipulation of the given object by the robotic manipulator, e.g. per the control signal outputted as part of the provided method 500. It can then be determined, based on the further depth data, whether the given object still exceeds the height threshold, e.g. as a check that the manipulation of the overheight object has resolved the overheight state for the container. In response to determining that the given object still exceeds the height threshold, a further signal representative of the container being in the overheight state is generated, for example. The further signal may be included in a request for teleoperation of the robotic manipulator to further manipulate the given object in the container.

For example, the further signal may comprise location data representative of the location of the given object in the scene represented in the further image. Such location information may be relative to the coordinate system of the robotic manipulator, for example. A further control signal, based on the further generated signal and configured to control the robotic manipulator to manipulate the given object in the container, is outputted in some examples. For example, the further control signal is generated by the requested teleoperation and is outputted to the robotic manipulator, e.g. the motion subsystem thereof, to be implemented in controlling the robotic manipulator.

As described in other examples, there may be multiple height thresholds. For example, the height threshold is a first threshold, the overheight state is a first overheight state, the signal is a first signal, and the control signal is a first control signal. The method may therefore involve determining, based on the depth data, whether the given object in the container exceeds a second height threshold less than the first height threshold. In response to determining that the given object exceeds the second height threshold and does not exceed the first height threshold, a second signal indicative of the container being in a second overheight state is generated, for example. Thus, the first and second signals can be used to distinguish between the first and second overheight states of the container, for example. Different responses can thus be made to the different overheight states of the container in such cases. For example, the method may involve outputting a second control signal, generated by a manipulation algorithm based on the generated second signal, configured to control the robotic manipulator to manipulate the given object in the container. A request, based on the generated first signal, for teleoperation of the robotic manipulator may be made when it is determined that the given object in the container exceeds the first height threshold (e.g. as well as the second height threshold). The first control signal, generated by the teleoperation of the robotic manipulator, may be outputted as part of the method in examples.

Control signals outputted as part of the method 500 are configured to control the robotic manipulator to manipulate the overheight object detected in the container. In some examples, the manipulation involves re-grasping the object, moving the object, and releasing the object in the container. In other examples, the manipulation is nonprehensile, e.g. moving the object in the container without grasping the object.

In some examples, the method 500 involves searching for points in the depth data which lie in a search region above the container. For example, the search region is defined, e.g. based on the (calibrated) image and a pose of the container, as a region of space above the container. The pose of the container represents a position and orientation of the container in space. For example, a six-dimensional (6D) pose of the container includes respective values in three translational dimensions (e.g. corresponding to a position) and three rotational dimensions (e.g. corresponding to an orientation) of the container.

The lower bound of the search region (in the z-direction) corresponds to the height threshold for determining whether the container is in an overheight state. As described in other examples, the upper bound of the search region (in the z-direction) may be set at a predetermined height or depth in space, or at a set depth differential from the lower bound, for example. The bounds of the search region in the x- and y-directions may be defined based on the dimensions of the container, e.g. based on a (CAD) model of the container and/or a direct height measurement of the container using depth data derived from the camera (e.g. a depth map of the container captured by the depth camera). In such examples, if it is determined that the search region is not empty, the container is determined to be in the overheight state.

The points present in the search region can be reprojected into the depth view to obtain a pixelwise detection. The pixelwise detection may be representable as a pixelwise detection map (or “heatmap”). The heatmap is a two-dimensional visualisation of the detected points in the search region, for example, projected onto a single plane in the z-direction. For example, the points detected in the search region are projected onto the bottom plane of the search region corresponding to the height threshold, with the heatmap comprising a map of points in the x-y directions and colour or gradient information representing the respective height of the points above the projection plane.

The pixelwise detection, e.g. heatmap, may be outputted as part of the method 500 in examples. In some cases, one or more locations of the overheight points or regions are outputted with the heatmap. For example, the pixelwise overheight detection is outputted with the signal indicative of the container being in the overheight state.

The method 500 described in examples can be implemented by a control system, e.g. one or more controllers, for a robotic manipulator, e.g. the control system previously described. For example, the control system includes one or more processors to carry out the method 500 in accordance with instructions, e.g. computer program code, stored on a computer-readable data carrier or storage medium.

Overall, the present systems and methods leverage the capabilities of a depth camera, e.g. which may already be mounted on the robotic manipulator, for detecting overheight containers between picks of items. The advantages in compactness make the present systems and methods suitable for employing in pick stations of an ASRS, for example on top of the grid structure in a cube-based storage system. In such implementations, one or more storage containers (or “totes”) may be placed at the on-grid picking station by one or more retrieval robots (or “bots”) for interaction with the on-grid robotic manipulator. The robotic manipulator is configured to pick items from containers (e.g. storage totes) and place them in other containers (e.g. delivery totes). Between picks by the robotic manipulator, the present systems and methods are employed to check whether either tote is in the overheight state with one or more items sticking out from the upper edge of the tote. In such a state, the retrieval bots may be unable to grip and lift the tote, e.g. with their tote-gripper-assembly. The on-grid robotic manipulator may thus be configured to resolve the overheight state, by manipulating the one or more overheight items detected in a given tote, before the tote is retrieved from the picking station by a retrieval bot.

In examples, the on-grid picking station may further comprise an optical sensor, which may be located on the upper surface of the plinth supporting the robotic manipulator. The optical sensor may be used in the identification of products in the picking process. The picking station may comprise a plurality of such optical sensors. In one example, the picking station may comprise four optical scanners, with one optical scanner being located at, or near to, each corner of the plinth. Each optical scanner may comprise a barcode reader. In an alternative arrangement, one or more barcode scanners may be installed on the robotic arm, such that the barcode scanner(s) move with the arm. In a specific implementation, two barcode scanners may be installed onto the arm.

The above examples are to be understood as illustrative. Further examples are envisaged. For instance, the obtained depth data may be based on a plurality of images captured respectively by a plurality of cameras at different respective locations or poses, e.g. using two colour cameras for stereo vision. The multiple images, for example, are processed to obtain a depth map.

Furthermore, the presented systems and methods involve obtaining and processing depth data. In many of the described examples, the depth data is captured by a depth camera, e.g. a type of camera comprising one or more depth sensors and configured to analyse a scene to determine distances of features and objects within the environment, from which the camera can create a 3D map of the scene. However, in other examples, the camera is not a specific depth camera and the depth data is obtained by processing (two-dimensional) image data captured by the camera.

The depth data is, therefore, based on an image captured by the camera, which may be a depth image or depth map captured by a depth camera or an image that does not initially contain depth information and is subsequently processed to obtain the depth data. For example, the depth data may be directly obtained from a depth camera, e.g. as a depth image or depth map outputted by the depth camera. Alternatively, there is an intermediate processing of the camera output to obtain the depth data. For example, a depth image captured by a depth camera is processed to obtain a point cloud. Alternatively, an image without depth information, captured by a camera, is processed to obtain a depth image indicative of the depth data.

Processing images to derive depth data that can be interpreted as an output image indicative of depth information can be done using computer vision techniques, e.g. involving machine learning. For example, a plurality of images captured by the camera can be processed to generate a depth map where the multiple images are captured at different locations and processed as stereo images. Alternatively, a single 2D image captured by the camera can be processed, e.g. by a trained neural network, to obtain depth information. Examples include using convolutional neural networks, deep neural networks, and supervised learning on segmented regions of images using features such as texture variations, texture gradients, interposition, and shading to make a scene depth inference from a single image. The process involves assigning a depth value to each pixel in the image, e.g. to convert an RGB image captured by an RGB camera into an RGB-D image of the type obtainable by a depth-sensing camera. For example, a depth estimator neural network is trained to determine a distance for every pixel in the colour image received from the camera (e.g. which is only able to return colour information from the scene in 2D). The neural network is trained, e.g. in a fully supervised manner, with the RGB image(s) as input and the estimated depth as output. A synthetic dataset may be used for the training of the neural network which, for example, includes RGB images, depth maps and semantic segmentation from stereo cameras. As described in examples, the output depth image can be used to derive a 3D point cloud.

Further examples of container overheight detection are envisaged in which machine learning is employed. For example, the control method may comprise obtaining image data, representative of an image of a container captured by a camera, following placement or removal of a first object into or from the container by the robotic manipulator. The camera may be a colour, e.g. RGB, camera or a depth camera from which a separate colour channel provides the image data. The image data is processed with a neural network trained to detect containers containing an object protruding beyond the top of the container, e.g. within a set tolerance. It is determined based on the processing whether the container in the image contains such an overheight object and is therefore in an overheight state. In response to a positive determination, a signal indicative of the container being in the overheight state is generated, as described in previous examples. A control signal based on the generated signal is output to control the robotic manipulator to manipulate the overheight object in the container.

In some cases, the neural network is trained to determine a binary classification mapping from the (colour) image data to the overheight determination, i.e. whether the container contains an overheight object or not. In other cases, the neural network is trained to determine a mapping from the (colour) image data input to an instance segmentation output, e.g. by an object detection model, wherein the overheight object in the image is identified and assigned a unique label/identifier, or pixel-level masking, wherein a pixel-level mask is generated for the identified object. In the latter, the mask specifies the image pixels belonging to that particular object, which allows for precise localisation and boundary delineation of each instance of an overheight object in the image. Thus, the signal indicative of the container being in an overheight state may include the localisation of the overheight object in the scene for the robotic manipulator to manipulate based on the control signal.

The mappings learned by the neural network during training may include depth data as well as colour image data in some examples. For instance, the neural network may be trained to determine a binary classification mapping from the combined image and depth data to the overheight determination, or a mapping from the combined image and depth data to the instance segmentation output. The output of the instance segmentation includes a list of bounding boxes and segmentation masks of where the overheight object is in the image, for example.

In examples where depth data is not available, e.g. where the camera does not have depth imaging capabilities, the segments for the overheight object in the captured image can be determined in other ways. For example, a dataset captured with a depth camera at another robotic pick station could be used for training the neural network to run instance segmentation based on colour images alone in the present system. Alternatively, an image classifier may be used to determine if an image includes a container in the overheight state, and if a positive determination is made, a multi-view stereo algorithm is implemented to generate depth information from which the overheight regions can be extracted as previously described. For example, the multi-view stereo algorithm causes the robotic manipulator to automatically move the camera and generate new depth data, e.g. a new point cloud, from images of the scene captured at one or more different pose. The methods previously described can then be used to extract the over-height regions from the depth data, e.g. the 3D point cloud.

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A method for controlling a robotic manipulator, the method comprising:
obtaining depth data, based on an image of a container captured by a camera, following placement or removal of a first object into or from the container by the robotic manipulator;
determining, based on the depth data, whether a given object, comprising the first object or a different second object, in the container exceeds a height threshold associated with the container;
generating, in response to determining that the given object exceeds the height threshold, a signal indicative of the container being in an overheight state; and
outputting a control signal, based on the generated signal, configured to control the robotic manipulator to manipulate the given object in the container.

2. The method according to claim 1, wherein the control signal is generated by teleoperation of the robotic manipulator.

3. The method according to claim 2, wherein the teleoperation is based on image data from another camera mounted on the robotic manipulator.

4. (canceled)

5. The method according to claim 41, wherein the control signal is generated by a manipulation algorithm is configured to generate control signals for the robotic manipulator based on image data from another camera mounted on the robotic manipulator.

6. The method according to claim 1, wherein the method comprises:
obtaining further depth data, based on a further image of the container captured by the camera, following manipulation of the given object by the robotic manipulator;
determining, based on the further depth data, whether the given object exceeds the height threshold;
generating, in response to determining that the given object exceeds the height threshold, a further signal representative of the container being in the overheight state; and
outputting the further signal in a request for teleoperation of the robotic manipulator to further manipulate the given object in the container.

7. The method according to claim 6, wherein the method comprises outputting a further control signal, based on the further generated signal, configured to control the robotic manipulator to manipulate the given object in the container.

8. The method according to claim 1, wherein the height threshold is a first height threshold, the overheight state is a first overheight state, the signal is a first signal, and the control signal is a first control signal, the method comprising:
determining, based on the depth data, whether the given object in the container exceeds a second height threshold less than the first height threshold;
generating, in response to determining that the given object exceeds the second height threshold and does not exceed the first height threshold, a second signal indicative of the container being in a second overheight state; and
outputting a second control signal, generated by a manipulation algorithm based on the generated second signal, configured to control the robotic manipulator to manipulate the given object in the container.

9. The method according to claim 8, wherein the method comprises outputting a request, based on the generated first signal, for teleoperation of the robotic manipulator to manipulate the given object in the container.

10. The method according to claim 9, wherein the method comprises outputting the first control signal generated by the teleoperation of the robotic manipulator.

11. The method according to claim 1, wherein the control signal is configured to control the robotic manipulator to regrasp the object, move the object, and release the object in the container.

12. The method according to claim 1, wherein the control signal is configured to control the robotic manipulator to manipulate the object in the container by nonprehensile manipulation.

13. The method according to claim 1, wherein the camera is mounted on the robotic manipulator.

14. The method according to claim 1, wherein the camera is configured for use in an automated pick-and-place process in which the robotic manipulator is controlled to pick and place objects between selected containers, from a plurality of containers including the container, based on images captured by the camera.

15. The method according to claim 1, wherein the height threshold corresponds to a top of the container.

16. The method according to claim 1, wherein the height threshold is a height between 1 mm and 50 mm above a top of the container.

17. The method according to claim 1, wherein determining whether the object exceeds the height threshold comprises searching for points in the depth data which are located in a predetermined search region defined based on the height threshold.

18. The method according to claim 17, wherein the search region is defined based on dimensions of the container.

19. The method according to claim 1, wherein the signal indicative of the container being in the overheight state comprises location data representative of a location of the given object.

20. The method according to claim 19, wherein the location data is representative of a location of the given object relative to the camera or the robotic manipulator.

21-23. (canceled)

24. A robotic packing system comprising;
a control system comprising one or more controllers configured to perform the method of claim 1; and
the robotic manipulator for packing an object.
